(19) United States
(12) Patent Application Publication
(10) Pub. No.: US 2003/0182026 A1
(43) Pub. Date: Sep. 25, 2003

(54) Method and system for adaptively controlling a plurality of automotive control system nodes based upon geographic location

(75) Inventors: Faisal M. Awada, Round Rock, TX (US); Joe Nathan Brown, Austin, TX (US); Victor Espinoza JR., Pflugerville, TX (US)

Correspondence Address: SAWYER LAW GROUP, P.O. Box 51418, Palo Alto, CA, 94303, US

(73) Assignee: International Business Machines Corporation, Armonk, NY

(21) Appl. No.: 10/104,722

(22) Filed: Mar. 21, 2002

(51) Int. Cl. G06F 17/00

(52) U.S. Cl. 701/1; 701/213

(57) ABSTRACT

A system and method for adaptively controlling a plurality of automotive control system (ACS) nodes of a vehicle is disclosed. In a first aspect, the system comprises a global position system (GPS) receiver for receiving a GPS signal indicating a geographic position of the vehicle. The system further includes a processor for receiving the indication of geographic position and geographic-based control data provided to the processor. The processor provides data to and controls the plurality of ACS nodes used based upon the geographic control data. In a second aspect, the method comprises receiving a GPS signal and determining the location of the vehicle based upon the GPS signal. The method further includes controlling at least one of a plurality of ACS nodes based upon the location of the vehicle. A system and method in accordance with the present invention allows a user to expand upon the position data stored in the ACS by entering customized data. Customization would allow the user to program the system to perform certain actions when the vehicle is in certain geographic locations. For instance, when a driver must pass through a school zone on a regular basis, the user could program the system to issue a warning each time the vehicle approaches the school zone.

### FIELD OF THE INVENTION

The present invention relates generally to automotive control systems and more particularly to a system and method to adaptively control such systems.

### BACKGROUND OF THE INVENTION

Certain types of information are stored in automotive control systems (ACS). ACS sensors control or adjust emissions, fuel to air mixture ratios, etc., within an automobile. The information stored in an ACS, which may differ according to which geographic region the automobile is sold in, determines key aspects of how the automobile functions. If the information stored within an ACS in an automobile is specific to a particular geographic region, when the vehicle is driven in a different region the automobile may not function optimally.

For example, sensor data within an ACS which controls emission control systems in an automobile may be tailored to the emission requirements of the particular area in which the car is being driven. At the present time, it is not possible to change this data in the ACS in order to adjust for different geographical areas in which a car may be operated. As a result, optimum emission adjustments, for example, may not be realized when an automobile is operated in a geographical area different from that for which the ACS information in the automobile was originally designed.

At present, it is also not possible to broaden the range of the amount and type of data which can be supplied to ACS control systems. Expanding the amount and type of information within the ACS would allow for a higher and more sophisticated level of control of the automobile. For example, additional information could make it possible to notify drivers of speed zones via a warning light or, if desired, to actually control the speed of the vehicle when it enters or approaches speed zones.

Accordingly, what is needed is a system and method for modifying the operational parameters of an auto control system based on the location of the automobile within a geographic region and for extending the amount and type of data that can be utilized by such a system. The present invention addresses such a need.

### SUMMARY OF THE INVENTION

A system and method for adaptively controlling a plurality of automotive control system (ACS) nodes of a vehicle is disclosed. In a first aspect, the system comprises a global position system (GPS) receiver for receiving a GPS signal indicating a geographic position of the vehicle. The system further includes a processor for receiving the indication of geographic position and geographic-based control data provided to the processor. The processor provides data to and controls the plurality of ACS nodes used based upon the geographic control data.

In a second aspect, the method comprises receiving a GPS signal and determining the location of the vehicle based upon the GPS signal. The method further includes controlling at least one of a plurality of ACS nodes based upon the location of the vehicle.

A system and method in accordance with the present invention allows a user to expand upon the position data stored in the ACS by entering customized data. Customization would allow the user to program the system to perform certain actions when the vehicle is in certain geographic locations. For instance, when a driver must pass through a school zone on a regular basis, the user could program the system to issue a warning each time the vehicle approaches the school zone.

### BRIEF DESCRIPTION OF THE DRAWINGS

FIG. 1 is a block diagram of an adaptive automotive control system 10 in accordance with the present invention.

FIG. 2 is a block diagram of the ACS geographic processor.

FIG. 3 is a block diagram of the nonvolatile memory which contains geographic based control data.

FIG. 4 is a flowchart illustrating a method for controlling the automotive control systems based upon geographic data.

### DETAILED DESCRIPTION

The present invention relates generally to automotive control systems and more particularly to a system and method to adaptively control such systems. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

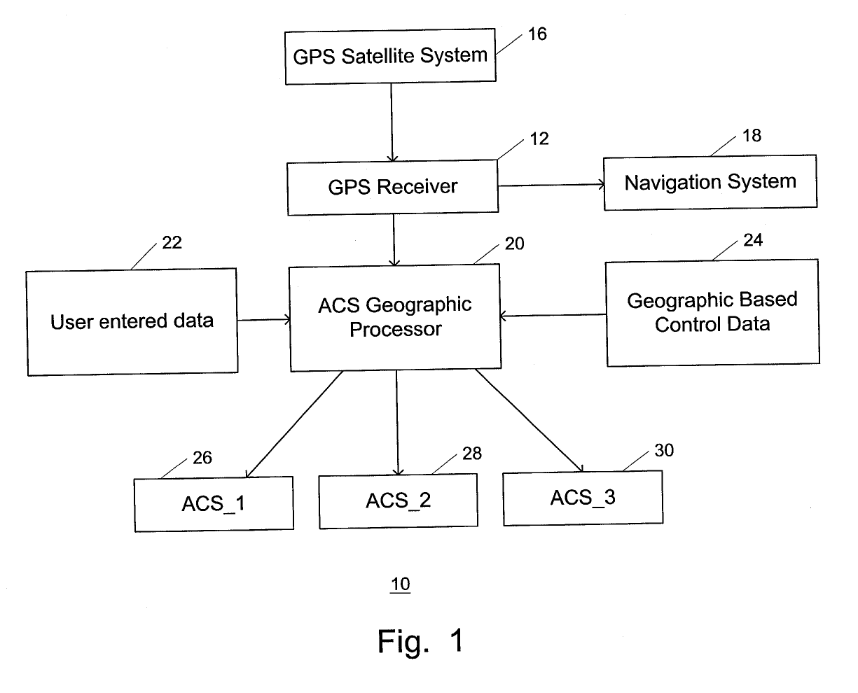

FIG. 1 is a block diagram of an adaptive automotive control system 10 utilized in a vehicle (not shown) in accordance with the present invention. The control system 10 includes a global positioning satellite (GPS) receiver 12 which receives a signal 14 containing positioning information which is transmitted from a GPS satellite/system 16. The GPS receiver 12 then processes the signal 14 in order to obtain the current geographic location of the vehicle. The GPS receiver 12 provides geographic location information to an optional navigation system 18 and an ACS geographic processor 20. The ACS geographic processor 20 also receives inputs via user-entered data 22 and geographic based control data 24. The ACS geographic processor 20 provides data to and controls a plurality of automotive control system (ACS1-ACSn) nodes 26, 28 and 30 within the vehicle based upon the geographic control data and the user-entered data.

ACS1 and ACSn nodes represent various automotive subsystems whose operational behavior can be modified by the input from the ACS geographic processor 20. These AC nodes could represent, for example, but not limited to, the vehicle's emission control system, the speed control system, the security system, battery power, tire compression, brake lining wear, oil pressure, temperature, lighting system and miles-per-gallon performance.

The outputs from the ACS geographic processor 20 are connected to the individual ACSs ACS1-ACSn. The ACS geographic processor 20 also has input from the user entered data 22. The user-entered data allow the user to customize the behavior of the system.

While the vehicle is being driven, GPS receiver 12 is constantly computing the geographic location of the vehicle and passing this information to the navigation system device 18 and the ACS geographic processor 20. The ACS geographic processor 20 compares the location information received from the GPS receiver 12 with the location information found in the geographic based control data 24 and in the user entered data 22. When a match is found, the ACS geographic processor 20 will fetch the corresponding operational data and pass it to the corresponding ACS node. The ACS node will then use the data in the operation of the system it is controlling.

Accordingly, through a system and method in accordance with the present invention, an automotive control system is adaptive based upon geographic information provided by the ACS nodes. In so doing, the performance of the vehicle can be enhanced, modified and controlled more efficiently. A key feature of the present invention comprises the geographic processor 20. To describe the geographic processor 20 in more detail, refer now to the following discussion in conjunction with the accompanying figures.

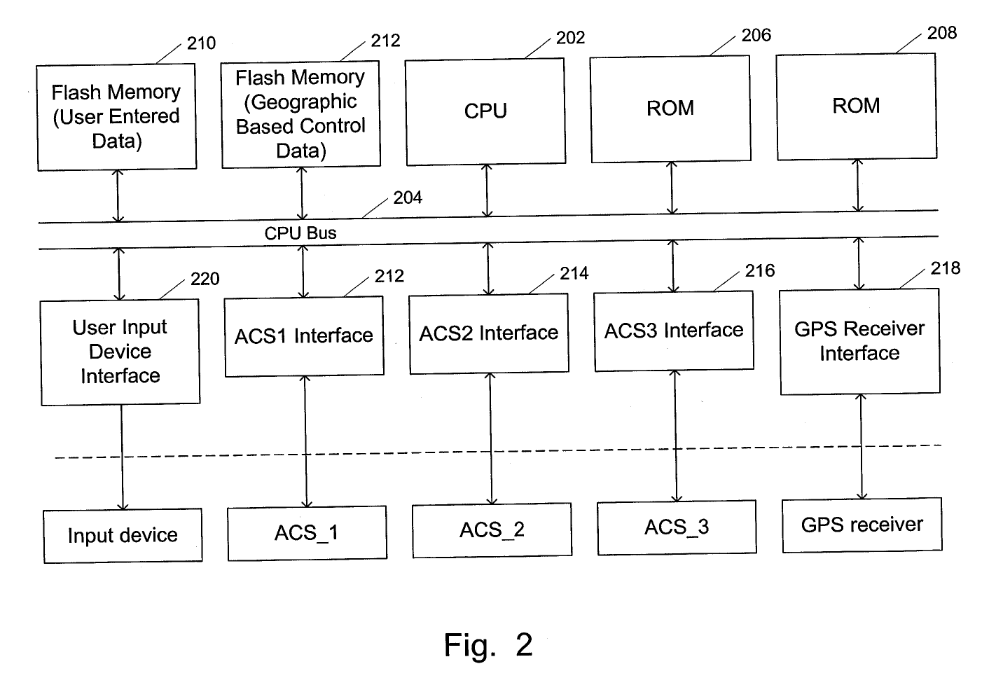

FIG. 2 is a block diagram of the ACS geographic processor 20. The ACS geographic processor 20 includes a CPU 202 coupled to a bus 204. A ROM 206 is coupled to bus 204 that contains operating instructions for the CPU. A RAM 208 is coupled to the bus for temporary data storage. The ACS geographic processor 20 further comprises a first nonvolatile memory 210 which contains user entered data for the automotive control systems and a second nonvolatile memory 212 containing geographic based control data. The processor 20 also includes a GPS receiver interface coupled to the bus 218 for obtaining position information of the vehicle. A user input device interface 20 receives the user-entered data. In addition, there are a plurality of ACS interfaces 212, 214 and 216 which correspond to ACS nodes of FIG. 1.

The second nonvolatile memory 212 interfaces to the ACS nodes 212-216 and provides the information to control the ACS nodes. For a further description of this feature, refer now to the following discussion.

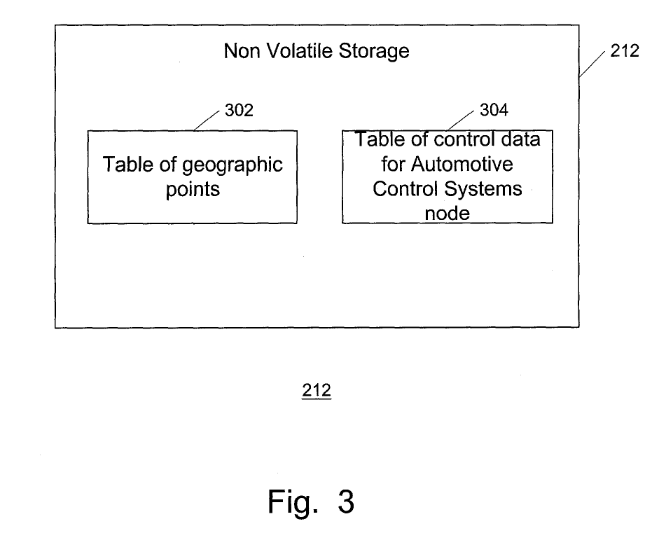

FIG. 3 is a block diagram of the nonvolatile memory device 212 which contains the geographic based control data. As before mentioned, the ACS geographic processor 20 (FIGS. 1) receives data from the nonvolatile memory 212. The nonvolatile memory 212 contains a table of geographic points 302 and a corresponding table of control data 304 for each of the Automotive Control System nodes (ACS1, ACS2 and ACSn). These tables are utilized by the processor 20 to control various ACS nodes. For a further description of the use of the NVM 212 by the processor 20, refer now to the following description.

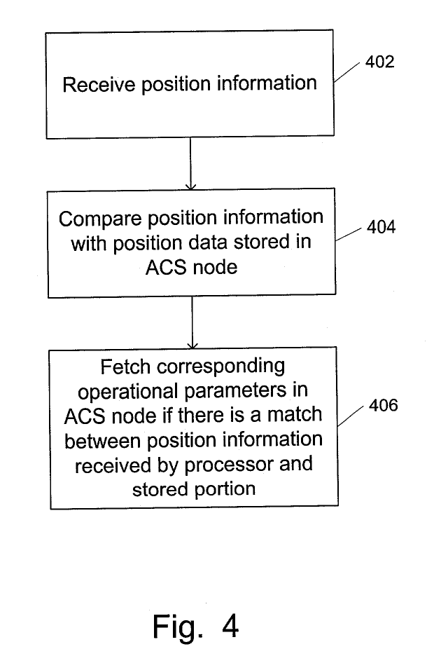

FIG. 4 is a flowchart illustrating a method for controlling the automotive control systems based upon geographic data. First, the current geographic position information is received by the processor 20, via step 402. Next, the ACS geographic processor 20 will compare the GPS position information to data already stored within the ACS node which represents various areas within the geographic region, via step 404. If the vehicle's current position matches an entry for the particular ACS in the stored data, the processor 20 will fetch the corresponding operational parameters to be used for controlling the ACS node, via step 406.

Accordingly, the tables of geographic points 302 (FIG. 3) is accessed by the process 20 and the entries therein are compared to retrieved geographic position. Thereafter, if there is a match (Table 304) of control data, the particular ACS node is utilized to provide the proper operational parameters.

A first embodiment of the method and system in accordance with the present invention would measure the barometric pressure, which could be replaced or supplemented. Such a system could adjust the fuel to air mixture based on the density of the atmosphere in a given region (the air in Denver, Colo., for example, is less dense than that in Austin, Tex.).

A second embodiment of the method and system in accordance with the present invention would set maximum vehicle speed could be set based on different geographical regions. If, for example, Texas decided that the maximum allowed speed for vehicles within its borders was to be 10 mph less than the rest of the country, the adaptive automotive control system could either limit the maximum speed of the vehicle accordingly or notify the user via a warning light/message that the vehicle is exceeding the speed limit. Such a system could also be utilized when a vehicle is within the city limits of a city where the speed limits are set at a lower maximum speed. Dealers would be able to augment the system to include adjustments for unique regional requirements of the region which the vehicle will operate in.

A third embodiment of the present invention would be to utilize the method and system to fine tune or set emission control systems based on the vehicle's geographic location.

In a fourth embodiment, an ACS can be programmed to disallow the use of a vehicle if its location is outside a designated geographic area, thereby acting as a deterrent to vehicles being stolen and shipped to other countries to be sold.

A system and method in accordance with the present invention allows a user to expand upon the position data stored in the ACS by entering customized data. Customization would allow the user to program the system to perform certain actions when the vehicle is in certain geographic locations. For instance, when a driver must pass through a school zone on a regular basis, the user could program the system to issue a warning each time the vehicle approaches the school zone.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A system for adaptively controlling a plurality of automotive control system (ACS) nodes of a vehicle comprising:
a global position system (GPS) receiver for receiving a GPS signal that indicates a geographic position of the vehicle;
a processor for receiving the indication of geographic position; and
geographic-based control data provided to the processor, wherein the processor provides data to and controls the plurality of ACS nodes used based upon the geographic control data.

2. The system of claim 1 which includes user-entered data provided to the processor, wherein the processor provides data to and controls the plurality of ACS nodes based upon the user-entered data.

3. The system of claim 1 wherein the processor comprises:
a bus;
a control processing unit (CPU) coupled to the bus;
a first storage medium for storing the geographic control data coupled to the bus;
a GPS receiver interface coupled to the bus and to the GPS receiver; and
a plurality of ACS node interfaces, each of the ACS node interfaces coupled to one of the plurality of ACS nodes.

4. The system of claim 3 wherein the geographic control data is provided via a first table of geographic points and a second table of control data for the plurality of ACS nodes.

5. The system of claim 1 which includes a navigation system coupled to the GPS receiver.

6. The system of claim 1 wherein ACS nodes comprise any combination of the vehicle's emission control system, the speed control system, the security system, battery power, tire compression, brake lining wear, oil pressure, temperature, lighting system and miles-per-gallon performance.

7. The system of claim 3 which includes a second storage medium that stores the user-entered data coupled to the bus and a user-input-device interface for receiving the user-entered data.

8. The system of claim 7 wherein the first and second storage mediums comprise first and second nonvolatile memories.

9. The system of claim 4 wherein the processor utilizes the first and second tables to control the plurality of ACS nodes.

10. A method for adaptively controlling a plurality of automotive system (ACS) nodes in a vehicle comprising the steps of:
(a) receiving a global positioning system (GPS) signal;
(b) determining the location of the vehicle based upon the GPS signal; and
(c) controlling at least one plurality of ACS nodes based upon the location of the vehicle.

11. The method of claim 10 wherein the controlling step (c) comprises the steps of:
(c1) providing location information to a processor;
(c2) providing geographic control data to the processor; and
(c3) utilizing the location information and the geographic control data by the processor to control at least one of the plurality of ACS nodes.

12. The method of claim 11 wherein the geographic control data is stored in a nonvolatile memory.

13. The method of claim 11 which includes user-entered data provided to the processor, wherein the processor provides data to and controls the plurality of ACS nodes based upon the user-entered data.

14. The method of claim 11 wherein the processor comprises:
a bus;
a control processing unit (CPU) coupled to the bus;
a first storage medium for storing the geographic control data coupled to the bus;
a GPS receiver interface coupled to the bus and to the GPS receiver; and
a plurality of ACS node interfaces, each of the ACS node interfaces coupled to one of the plurality of ACS nodes.

15. The method of claim 11 wherein the geographic control data is provided via a first table of geographic points and a second table of control data for the plurality of ACS nodes.

16. The method of claim 11 wherein ACS nodes comprise any combination of the vehicle's emission control system, the speed control system, the security system, battery power, tire compression, brake lining wear, oil pressure, temperature, lighting system and miles-per-gallon performance.

17. A system for adaptively controlling a plurality of automotive control system (ACS) nodes of a vehicle comprising:
a global position system (GPS) receiver for receiving a GPS signal indicating a geographic position of the vehicle;
a navigation system coupled to the GPS receiver;
a processor for receiving the indication of geographic position, the processor further comprising a bus; a control processing unit (CPU) coupled to the bus; a first storage medium for storing the geographic control data coupled to the bus; a GPS receiver interface coupled to the bus and to the GPS receiver; a plurality of ACS node interfaces, each of the ACS node interfaces coupled to one of the plurality of ACS nodes, wherein the processor provides data to and controls the plurality of ACS nodes based upon the user-entered data; a second storage medium that stores user-entered data coupled to the bus; and a user-input-device interface for receiving the user-entered data;
user-entered data provided to the processor; and
a geographic-based control data provided to the processor, wherein the processor provides data to and controls the plurality of ACS nodes used based upon the geographic control data and the user-entered data, wherein the geographic control data is provided via a first table of geographic points and a second table of control data for the plurality of ACS nodes.

18. The system of claim 17 wherein ACS nodes comprise any combination of the vehicle's emission control system, the speed control system, the security system, battery power, the composition brake lining wear, oil pressure, temperature, lighting system and miles-per-gallon performance.

19. The system of claim 17 wherein the first and second storage mediums comprise first and second nonvolatile memories.

20. The system of claim 20 wherein the processor utilizes the first and second tables to control the plurality of ACS nodes.

21. A computer readable medium containing program instructions for adaptively controlling a plurality of automotive system (ACS) nodes in a vehicle, the program instructions for:
(a) receiving a global positioning system (GPS) signal;
(b) determining the location of the vehicle based upon the GPS signal; and
(c) controlling at least one plurality of ACS nodes based upon the location of the vehicle.

22. The computer readable medium of claim 21 wherein the controlling step (c) comprises the steps of:
(c1) providing location information to a processor;
(c2) providing geographic control data to the processor; and
(c3) utilizing the location information and the geographic control data by the processor to control at least one of the plurality of ACS nodes.
